(19) United States
(12) Patent Application Publication
(10) Pub. No.: US 2023/0419502 A1
(43) Pub. Date: Dec. 28, 2023

(54) SOFTWARE METHOD FOR OPTO-SENSORY DETECTION, MEASUREMENT AND VALUATION OF TOOL CONDITIONS

(71) Applicant: TECHNISCHE UNIVERSITÄT DRESDEN, Dresden (DE)

(72) Inventors: Thomas HERLITZIUS, Dresden (DE); Samuel PANTKE, Dresden (DE); Patrick ZIRKER, Dresden (DE); Martin HENGST, Dresden (DE); Sören GEISSLER, Dresden (DE)

(73) Assignee: TECHNISCHE UNIVERSITÄT DRESDEN, Dresden (DE)

(21) Appl. No.: 18/251,495

(22) PCT Filed: Nov. 1, 2021
(86) PCT No.: PCT/EP2021/080268

§ 371 Date: May 2, 2023

(30) Foreign Application Priority Data
Nov. 2, 2020 (DE) 10 2020 128 759.3

(51) Int. Cl. G06T 7/194; G06T 7/60; G06T 5/50

(52) U.S. Cl. CPC G06T 7/194; G06T 7/60; G06T 5/50

(57) ABSTRACT

The invention relates to a computer-implemented method for the optical sensing, the detection and the quantification of relevant conditions and/or their changes with respect to at least one target object, wherein at least one target object is temporarily positioned opposite an optical sensor device, and wherein the fault conditions of the fault classes deviate from the optimal condition. The method is characterized particularly in that the background and the target object are distinguished by means of a higher rate of change of the image information of the background in comparison with the rate of change of the image information of the target object.

The invention relates to a computer-implemented method for evaluating sensor information of a tool, in particular of a tool suitable for soil cultivation.

In the course of increasing automation, the monitoring of mechanically stressed components, such as tools for soil cultivation, is frequently coupled to optical systems. In agricultural engineering, the monitoring of wear-intensive tools, for example for soil cultivation, is frequently not yet sufficiently achieved. The prior art is the visual monitoring and assessment of wear parts by the machine operator. Sensor systems, e.g., optical systems, are also increasingly used for monitoring and valuation. In addition to mere monitoring, the valuation of the current condition of the monitored tool is also of crucial importance. The valuation with respect to the degree of wear frequently takes place by means of wear marks as a mechanical embodiment at critical locations of the respective tools or simply by means of operating hours counters. In the prior art, there are also solutions which operate by means of photo-optical comparisons, with the exception of agricultural engineering. Here, no systems that monitor the tools for soil cultivation photo-optically have been known so far.

U.S. Pat. No. 6,479,960 B2 discloses a machine tool in which, even with a low cutting load and/or low strength of a tool, it can be established automatically whether the tool is defective or not. Furthermore, the miniaturization of such a machine tool is described with the purpose of achieving a cost saving. According to the primary aspect, the machine tool comprises a photographing unit, which photographs an image of the tool, and a determination unit, which determines whether or not the tool is defective based on the images obtained from the photographing unit. In this case, a defective tool is detected without contact on the basis of an image comparison.

DE 10 2008 045 470 A1 describes a method for ascertaining the wear condition of a milling tool, in particular a bit, a bit holder and/or a bit holder changing system. For this purpose, the position of at least one point of the bit and/or of the bit holder is ascertained by means of a measuring method. The measurement result or a calculation of the measurement result is compared in a switching unit to at least one reference value stored in a storage unit.

AU 2014262221 B2 discloses a method and tool for monitoring the condition, the maintenance condition and the performance of wear parts that are used in soil cultivation devices. The process and the tool enable the operator to optimize the performance of the soil cultivation device. During use, the tool has a clear positional relationship to the wear parts and is used together with a blade or a shield on the soil cultivation device. The entire monitoring system comprises an excavator bucket with walls defining an enclosure portion for collecting soil materials, a digging edge, at least one wear part fastened to the digging edge, at least one electronic sensor fastened to one of the walls, and a programmable logic device. The logic device receives information from the at least one electronic sensor and determines the conditions of the presence of the bucket, the maintenance condition or the degree of wear, the filling and performance of the bucket and/or of the at least one wear part.

The photo-optical methods mentioned are solely dependent on photographs of the machines/parts or tools to be monitored. In moving machines/parts or tools, these photographs are often subject to large disturbing influences due to their movement. These disturbing influences are amplified by additional image information, e.g., by an uneven background. The use of operating hours as a measure of wear is a static variable which does not in any way take account of the actual condition of the tool to be monitored.

The use of wear marks always requires an additional work step in the production of tools or the working machines to be monitored.

The object of the invention is therefore to overcome the obvious disadvantages of the prior art, to customize the monitoring and valuation of tool conditions, and to make them independent of disturbing influences.

The object is achieved by the features of the independent claims. Preferred embodiments are the subject matter of the dependent claims in each case.

To this end, according to the invention, a computer-implemented method for optically sensing, for detecting and quantifying relevant conditions and/or their changes on at least one target object has the following steps:
a) recording an image sequence, wherein each image of the image sequence contains at least the target object and/or at least the section of the target object;
b) comparing at least two of the images of the image sequence to one another and establishing commonalities and/or establishing differences between the at least two images of the image sequence;
c) segmenting all images of the image sequence into background and foreground, or vice versa;
d) identifying at least one target object in the foreground;
e) determining relevant image points of the target object;
f) measuring at least one geometric property of the target object on the basis of relevant image points;
g) comparing the geometric properties of the target object to the geometric properties of a comparison object; and
h) classifying the condition of the target object into
an optimal condition,
at least one fault class with respect to the condition of the target object, and/or
classifying the condition of the measurement system into
an optimal condition or
at least one fault class,
wherein the at least one target object is arranged at least temporarily opposite an optical sensor device, and wherein the conditions of the fault classes differ from the optimal condition, characterized in that
the background and the target object are distinguished by means of a higher rate of change of the image information of the background in comparison with the rate of change of the image information of the target object.

For example, but not exclusively, digital image information is converted into the frequency space by means of a fast Fourier transform. The portions of the thus calculated frequency data set that describe the color changes and/or contrast changes with a high temporal fluctuation are removed.

According to the invention, the background and the target object are thus distinguished by means of a higher rate of change of the image information. Here, the extent of the change in image information over a particular time period in relation to the duration of this time period is understood as the rate of change of the image information, and the rate of change of the image information is thus a measure of how quickly image information changes. As a result of the relation to the time period, the unit of measure contains a time unit in the denominator, and a unit of the image information, e.g., a byte, is in the numerator.

In the following, the target object is the object that is subjected to opto-sensory monitoring. In general, tools for soil cultivation are understood here as a non-exhaustive example.

In the following, “relevant conditions” are understood to mean the conditions of the target object that are considered to be relevant in an application-specific manner. Thus, for example, but not exclusively, the degree of soiling can be classified as relevant if the possibility for opto-sensory sensing is thereby impaired too much. Loss, destruction, deformation, displacement, soiling and/or wear thus also fall into the category of the relevant conditions. It is also conceivable that no change to the target object is classified as relevant.

Image segmentation is understood to mean a partial area of digital image processing. In this case, the generation of regions connected in terms of content by combination, in pixels or voxels, corresponding to a freely selected criterion is referred to as segmentation.

In embodiments of the invention, the position of the target object and/or of the section of the target object relative to the edges of the image does not change on average over time. Thus, it is easier for the algorithm to carry out image segmentation and to identify the target object or the section of the target object.

In embodiments of the invention, the determination of the position of the target object relative to the edges of the image is made more difficult by a vibration movement. By adapting the sampling rate of the camera to higher harmonics of the vibration and/or changed sampling, a condition of relative constancy of the distances of the target object from the image edges is produced. Frequently, software adaptations in the algorithm that controls the camera controller or the sampling rate thereof are sufficient. This is advantageous since no changes to the embodiment of the actual sensor system have to be carried out in this way.

In embodiments of the invention, the optical sensor system is supplemented by a stroboscopic light source. In this case, the frequency of the light flashes is selected in such a way that the illuminated target object appears to be relatively constant with respect to the edges of the image or with the drift movement distinguishable from the movement of the background. This is advantageous since objects guided periodically past the optical sensor system can thus also be made accessible to the method.

In embodiments of the invention, a plurality of image sequences is recorded according to the invention. These image sequences are divided into different sequences. After the subdivision into sequences, at least one sequence of the image sequence is subjected to a method for averaging image information in order to improve the image quality of the sequences. The methods for averaging image sequences are, for example, but not exclusively, a sliding weighted average (mᵢ=nᵢ*x+nᵢ₋₁*(1−x)) or Gaussian filter to {nᵢ, . . . , nᵢ₋ₓ}, and the weights or parameters are in this case dependent on the image frequency in order to compensate for errors in the sampling rate. If more than one averaging is used in parallel in the case of differently broad frequency bands of the sampling rate, this is the basis for the band-pass filtering which already represents the central segmentation.

This is advantageous since a further reduction of the systematic error source of the random movements of the target object, e.g., unwanted vibrations caused by shaking or by coupling in resonant motor frequencies, is brought about in this way. This increases the efficiency of the entire method in a simple manner since the interesting object properties are precisely not in the frequency spectrum and the amplitudes of the machine vibrations and movements and thus identify themselves very easily.

In embodiments of the invention, the comparison object contains the measurement data of the geometric object information for comparison with the target object from a normal reference.

In embodiments of the invention, the normal reference comprises a model adaptation to possible condition classes. Thus, for example, a target object, or tool, in operation is checked with respect to its degree of wear. If a user finds the latter to be suitable despite significant signs of wear, the model to be referenced and the associated model data are adapted to this condition.

This is advantageous since a locally valid reference can be created in this way even in the event of data loss during operation. The method is thus enabled to calibrate itself independently of calibration standards and to check against that calibration.

In embodiments of the invention, self-referenced model data are used to achieve the best possible condition with correction algorithms and to in this way create a calibration standard autonomously. This is advantageous since, in the case of a tool change, individual adaptation to the changed system can thus be performed.

In embodiments of the invention, the comparison object is available as a virtual comparison object in all classifications of the condition. Thus, for example, but not exclusively, a database is created in which all error messages that previously occurred are stored with the associated sensor data and virtual data. By comparing the data within a fault class, it is thus advantageously possible to provide a detailed model of the respective fault class for comparison or as a comparison object. Self-learning and self-improving these comparison objects is also advantageously made possible in this way.

In embodiments of the invention, the geometric object information of the comparison object is available from model data. In this case, for example, but not exclusively, at least one true-to-scale model of the target object to be monitored is produced as a real embodiment. On the basis of such models, possible different fault classes are represented and investigated with regard to the resulting dimensions or are used, for example, but not exclusively, by means of a direct image comparison of model and target object.

In order to perform the computer-implemented method, data processing units are used which are connected locally at the place of use and/or via remote transmission to the necessary sensor systems for data recording. Furthermore, computer-readable storage media in which a computer program product suitable for executing a computer-implemented method are used to, likewise, but not exclusively, store the comparison data of the individual fault classes.

Output values of the computer-implemented method can serve as input parameters of a regulating and/or control unit.

Thus, for example, but not exclusively, an exemplary test setup is monitored by the method. The tangible equivalent of the system is located in an environment which enables sensory monitoring only to a limited extent. If output values for particular fault classes are now obtained from the model test, they can be transmitted to the regulation or control, for example by hand, from the model test to the control of the real system.

In order to realize the invention, it is also expedient to combine the above-described embodiments and the features of the claims.

FIG. 1 is a schematic sketch of a possible exemplary embodiment of the invention. This is a main frame/support frame (1), wherein the individual components of the sensor system according to the invention are shown. The main frame serves as a basis for attaching the at least one required camera (4) according to the invention and for attaching the tool module (2). At least one tool (3) is located on the tool module and can be described according to the invention as a target object. The background of the machine system (6) and a computer (5), which is necessary for evaluating the sensor data, are also part of the measurement setup.

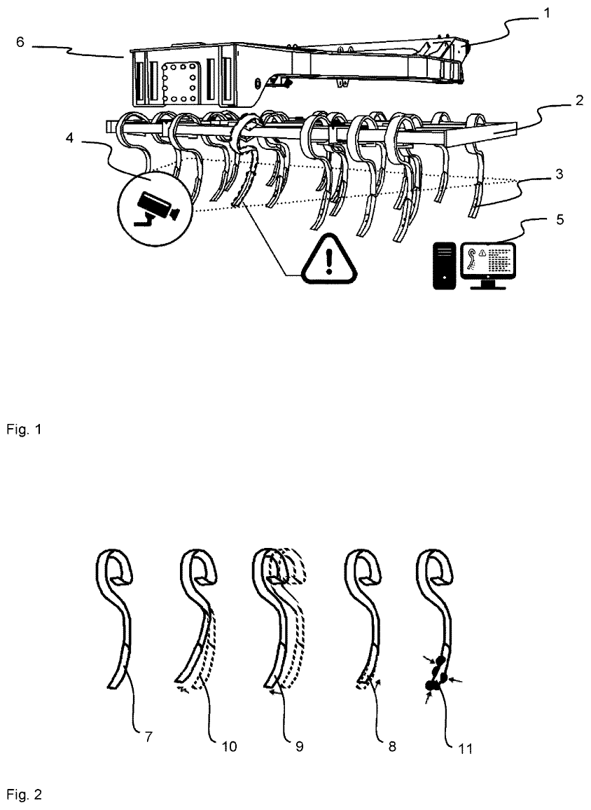

FIG. 2 shows various conditions of the tools which can be detected by the system.

FIG. 3 shows, by way of example, possible tool shapes whose condition can be assessed using the method according to the invention.

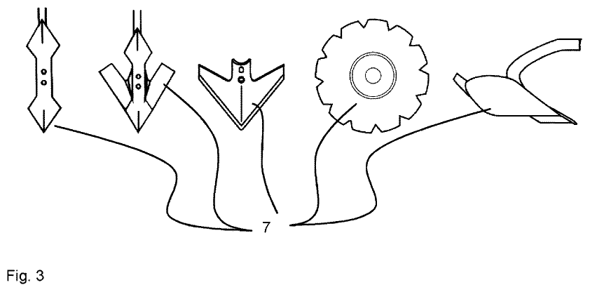

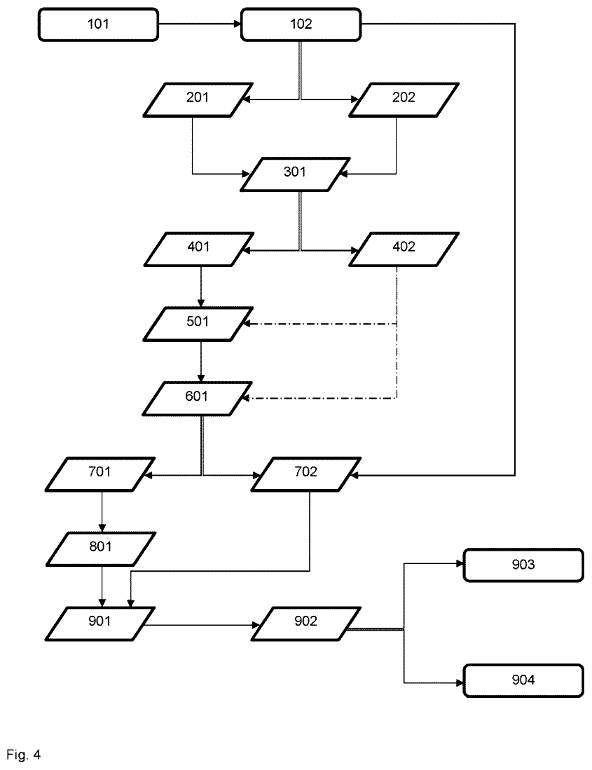

FIG. 4 schematically shows the flow of the computer-implemented method according to the invention in its basic functions.

In one exemplary embodiment, the condition of the individual tools of an agricultural device for soil cultivation (here a spring tine cultivator) on a support frame (1) is assessed according to the method according to the invention. For this purpose, the optical sensor (4) is mounted on the support frame (1). The sensor (4) is, as it were, connected to a valuation unit, the computer (5), in such a way that the sensor data can be transmitted according to the invention. A tool module (2), which carries the individual tools (3), is, as it were, mounted on the support frame (1). In one embodiment of the invention, however, the support frame (1) can also contain only a plurality of individual tools (3) that are directly connected to the support frame (1) without a tool module (2). The number of optical sensors (4) and of individual tools (3) is at least one. Thus, different numbers of sensors are possible for different requirements from the measurement task.

With the aid of the sensor (4), at least one tool (2), which forms the target object, is sensed. At the same time, the background (6) is likewise sensed in the sensor section.

FIG. 4 shows the program flow. Sensing starts with the start command/trigger in the software. The start command may, for example, be issued automatically on the basis of position sensors of the tools or manually by an operator. An image with a time stamp is sensed. On the basis of the recording of an image sequence, the image is segmented into foreground and background with the aid of averaging methods. The target objects (3) can be determined therefrom in the foreground. The background information can likewise be used for determining the machine movement as aids for tolerance parameters of the measurement. After the determination, the foreground object is structured in order to identify characteristic geometries (skeleton or edges). In the ascertained characteristic shapes, measuring points are subsequently ascertained, which are compared to a model object, or direct measurements can take place starting from the position of the measuring points. When assigning the measuring points by means of a model object, the condition parameters must subsequently be determined indirectly. Finally, the individual tools and thus the machine condition can be classified. Classification can be understood as ascertaining predefined conditions. The conditions of the tool(s) can result in instructions and/or are quantified as well as output and stored as a measurement signal/condition. The measured values can in turn be used as control parameters for the tools, such as adjustment of the working depth, compensation of topological conditions. The condition classes are defined as follows:
Condition 1: Tool in order, status message (FIG. 2, pos. 7)

In this case, the individual tool and/or the entire tool module satisfies the requirements and does not require any actions.
Condition 2: Tool worn, status message and measured value output (FIG. 2 pos. 8)

If a wear limit value is reached or exceeded, a status message is output and, at the same time, a measured value is ascertained, which provides, to the user or a control, information about the remaining working time until an action is necessary, for example. A tool break, e.g., also represents a wear condition, which, however, occurs suddenly and not in a continuously progressing manner. This condition is thus a special case of condition 2.
Condition 3: Tool displaced (FIG. 2 pos. 9)

If an overload of the tool subsequently occurs, a lateral displacement or dislocation of the tool can occur, which in turn has a negative effect on the work result. An immediate action can be derived therefrom if a permissible limit value has been exceeded. A status message with possibly a measured value is output to the operator or the control.
Condition 4: Tool deformed (bent) (FIG. 2 pos. 10)

Overloading the tool can also cause a permanent deformation in the tool, which can be negative for the desired work result. Therefrom, the system generates a status message indicating whether the shape of the tool is within predefined limits.
Condition 5: Tool soiled/not detectable.

If soiling of the tool occurs as a result of harvesting residues or the like, characteristic geometric shapes can no longer be detected. In this case, it is not possible to determine measured values. Here, the system must provide a status message about the soiling in order to initiate countermeasures.

With the sensor system according to the invention, a wide variety of shapes of tools can be sensed and analyzed. FIG. 3 shows exemplary embodiments of individual tools.

All these conditions can be taken into account as control parameters in the control and/or displayed to an operator and/or stored in a machine-readable form.

### REFERENCE SIGNS

1 Support/main frame
2 Tool module with tool frame
3 Target object
4 Optical sensor
5 Data processing unit
6 Background
7 Original condition
8 Relevant condition “Worn”
9 Relevant condition “Shifted” or “Displaced”
10 Relevant condition “Deformed”
11 Relevant condition “Soiled”
101 Trigger (timer)
102 New frame (with time stamp)
201 Averaging the image sequence for suppressing machine-induced noise
202 Averaging the image sequence for suppressing machine movement
301 Segmenting into foreground and background
401 Foreground: Ascertaining the movement/current position
402 Background: Determining the machine movement as tolerance parameters
501 Identifying relevant structures of the target object, for example its skeleton or its edges (structuring)
601 Determining relevant image points of the target object
701 Option 1 after 601: Assigning the measuring points to a model object
702 Option 2 after 601: Directly determining the condition parameters from the position of the relevant image points
801 Indirectly determining condition parameters
901 Classifying (and optionally qualifying) the machine condition
902 Weighted average from a plurality of perspectives
903 Outputting condition (e.g., visual representation)
904 Outputting measurement signal (e.g., for machine control)

1. Computer-implemented method for optically sensing, for detecting and quantifying relevant conditions and/or their changes on at least one target object, having the following steps:
a) recording an image sequence, wherein each image of the image sequence contains at least the target object and/or at least the section of the target object;
b) comparing at least two of the images of the image sequence to one another and establishing commonalities and/or establishing differences between the at least two images of the image sequence;
c) segmenting all images of the sequence into background and foreground, or vice versa;
d) identifying at least one target object in the foreground;
e) determining relevant image points of the target object;
f) measuring at least one geometric property of the target object;
g) comparing the at least one geometric property of the target object to at least one geometric properties of a comparison object; and
h) classifying the condition of the target object into
an optimal condition,
at least one fault class with respect to the condition of the target object, and/or
classifying the condition of the measurement system into
an optimal condition or
at least one fault class,
wherein the at least one target object is arranged at least temporarily opposite an optical sensor device, and wherein the conditions of the fault classes differ from the optimal condition, characterized in that
the background and the target object are distinguished by means of a higher rate of change of the image information of the background in comparison with the rate of change of the image information of the target object.

2. Computer-implemented method according to claim 1, characterized in that the position of the target object and/or the section of the target object relative to the edges of the image remains constant on average over time.

3. Computer-implemented method according to claim 1, characterized in that at least one sequence of adjacent images of the image sequence is subjected to a method for averaging image information.

4. Computer-implemented method according to claim 1, characterized in that the comparison object contains the measurement data of the geometric object information for comparison with the target object from a normal reference.

5. Computer-implemented method according to claim 4, characterized in that the normal reference comprises a model adaptation to possible condition classes.

6. Computer-implemented method according to claim 1, characterized in that the comparison object is available as a virtual comparison object in all classifications of the condition.

7. Computer-implemented method according to claim 1, characterized in that the geometric object information of the comparison object is available from model data.

8. Use of a data processing unit for performing a computer-implemented method according to claim 1.

9. Use of a computer-readable storage medium, on which a computer program product suitable for executing a computer-implemented method according to claim 1 is stored.

10. Use of the output values of the computer-implemented method according to claim 1 as input parameters of a regulating and/or control unit.
